(19) United States
(12) Patent Application Publication
(10) Pub. No.: US 2004/0152204 A1
(43) Pub. Date: Aug. 5, 2004

(54) Method and device for forming tissue sample blocks

(76) Inventor: Pierre Gauthier, St-Charles Borromee (CA)

Correspondence Address: Pierre Gauthier, 32, Belleville, St-Charles Borromee, QC, J6E 8A4, CA

(21) Appl. No.: 10/646,866

(22) Filed: Aug. 25, 2003

(30) Foreign Application Priority Data
Aug. 23, 2002 (GB) 0219642.6

(51) Int. Cl. G01N 1/00

(52) U.S. Cl. 436/174

(57) ABSTRACT

A method and device for using part of the tissue margin of an excised tissue specimen and a coating gel to form a sample block sliceable into sample slices. The method includes the steps of: positioning the part of the tissue margin on a substantially flat tissue supporting surface with its deep surface positioned adjacent or against the tissue supporting surface; covering the part of the tissue margin with an initial volume of coating gel; using a mold for molding the part of the tissue margin covered by the initial volume of coating gel into the sample block having a predetermined configuration and a predetermined size; at least partially freezing the sample block while the sample block remains inserted in the mold; removing the sample block from the mold. The device includes and sleeve component and a piston component having a tissue supporting surface. The sleeve wall is configured and sized for substantially fittingly receiving the piston component and allowing reciprocating movement thereof along the sleeve longitudinal axis. The device also includes a molding plate configured and sized so as to be positionnable in a plate molding configuration wherein a molding surface thereof extends across the sleeve channel substantially adjacent the sleeve first end. When the molding plate is in a plate molding configuration, the molding surface, the supporting surface and the sleeve inner surface together encompass a molding volume for molding the sample block.

### FIELD OF THE INVENTION

The present invention relates to the general field of tissue preparation and is particularly concerned with a method and a device for using part of the tissue margin or all the tissue margin of an excised tissue specimen and a coating gel to form a sample block sliceable into sample slices using a microtome knife.

### BACKGROUND OF THE INVENTION

Surgical removal or biopsy of a tissue specimen for histological examination is commonly used as a diagnostic tool for helping in establishing a precise medical diagnosis. Typically, when a lesion is suspected or known to be malignant, the entire mass of the lesion is preferably excised. Also, an examination technique is preferably further employed in which the tumor margin surface area is examined. The examination technique typically involves microscopic screening of the exterior surface area of the tumor mass for the presence of malignant cells to ensure that all such cells have been removed.

Tumor margin surface area examination if practiced effectively enhances the likelihood of complete removal of all cancerous cells of a localized malignancy. If it is estimated that the removal of the malignancy is not complete, a method may be used to precisely identify the location of any residual malignancy for subsequent removal or, when it is not possible to remove the malignancy through surgery, radiation therapy can be used.

One particularly popular surgical technique for removing skin tumors such as cutaneous malignancies and certain major carcinomas is the so called Mohs surgical technique developed by Frederic E. Mohs. The Mohs technique involves evaluating thin sections or slices of the removed tissue under a microscope.

The Mohs surgical technique requires excising a tissue sample that includes the skin tumor to be removed. Typically, the surface of the excised tissue sample has a generally curved or bowl-shaped configuration resulting from the passage of the scalpel below the surface of the skin. The generally parabolic cross section of the excised tissue sample is typically marked for orientation purposes in order to allow the surgeon to determine where additional excisions must occur should the results of an inspection of a microscopic section of the tissue sample indicate that the tumor has spread beyond the excised tissue sample.

For the Mohs surgical technique to be successful, high quality frozen tissue sections must be produced and microscopically review to determine whether any residual tumor has spread beyond the tissue sample. In order for the high quality frozen tissue sections to be obtained, the excised tissue sample having a generally parabolic cross sectional configuration must be converted to a tissue block having a generally planar cross sectional configuration.

The conversion of the cross section from a curved to a generally planar configuration is necessary in order to obtain successful cryostat sectioning. Indeed, in order to obtain high quality horizontally cut frozen tissue sections, the cutting tool must be provided with a generally planar surface generally parallel to the path of relative movement between the cutting knife and the specimen. This ensures sections of generally uniform thickness suitable for microscopic examination.

The cutting tool used for slicing the excised tissue in thin slices or sections is often referred to as a microtome. The microtome is typically located in a refrigerated unit called a cryostat, capable of maintaining an internal temperature of −20° C. or less.

Typically, in order to enable slicing of the excised tissue, the latter is mounted on a cryostat chuck with the planar or flattened surface of the excised tissue exposed and perpendicular to the longitudinal axis of the cryostat chuck. Conventional cryostat chucks are provided with chuck fixtures into which the chuck and tissue sample mounted thereon can be placed to allow the cryostat to cut the tissue sample into frozen section having a thickness of a few micrometers.

Once the sections have been sliced, they are typically placed on a microscope slide prior to being stained by dipping the slide in various dye solutions and solvents. Once the desired amount of staining is obtained, a covering substance such as a clear glue-like substance such as “Baume du Canada” is used to attach a thin layer of glass called a cover slip. Dying of the tissue slices enables a skilled person to determine with relative accuracy whether cancerous cells are present in the section being examined.

Although the conventional Mohs technique is quite useful, some of its steps especially when performed with prior art devices suffer from numerous drawbacks. One of the difficulty associated with the conventional Mohs technique is that in order to obtain a tissue slice that includes the entire flattened, formerly bowl-shaped surface, including the epidermal periphery thereof, the plane in which the flattened formerly bowl-shaped surface lies must be substantially parallel to the plane in which the cryostat knife moves relative to the tissue sample.

With conventional methods of performing the Mohs surgical technique, the excised bowl-shaped tissue sample is typically positioned on the supporting surface so as to form a generally convex configuration. Hence, the deepest tissue section, or the bottom of the bowl, points upwardly relative to the supporting surface.

In order to flatten the inverted bowl-shaped tissue sample small lacerations are sometimes performed with the help of a scalpel or other cutting tool. Since the tissue sample is positioned in an inverted bowl-shaped configuration, the lacerations are often performed on the deepest part of the excision providing crucial information. Laceration of this crucial area of the excised tissue may potentially lead to difficult interpretation of the results. Also, the need for inverting the orientation of the excised tissue is both tedious and time consuming. The need for inverting the orientation of the tissue also potentially leads to manipulation errors.

If the planar surface of the formerly bowl-shaped surface is not parallel to the path of relative movement between the cryostat knife and the tissue sample, the first section performed by the cryostat knife may not include the entire formerly bowl-shaped surface.

In such situations, the surgeon must review subsequent deeper sections until he or she determines that the entire formerly bowl-shaped surface has been evaluated. This can be a time consuming effort since each section must first be stained and then microscopically examined and interpreted by the surgeon before determination can be made as to whether further incision of tissue is necessary.

If a tumor is encountered prior to the first section being completed, the resulting interpretation may be falsely positive requiring an additional excision of tissue sample. This additional excision may potentially lead to unnecessary injury of adjacent vessels, nerves or the like.

Furthermore, if the excised tissue sample is folded unto itself, the folded section may contain cancerous cells leading to falsely negative results. Accordingly, there exists a need for an improved method and device for tissue preparation of excised tissue samples.

### SUMMARY OF THE INVENTION

In accordance with the present invention, there is provided a method for using part or all of the tissue margin of an excised tissue specimen and a coating gel to form a sample block sliceable into sample slices, the part or all of the tissue margin defining a peripheral section and a core section, the part or all of the tissue margin also defining a shallow surface and a substantially opposed deep surface, the method comprising the steps of: positioning the part or all of the tissue margin on a substantially flat tissue supporting surface with the deep surface positioned adjacent or against the tissue supporting surface. Normally, when the specimen is at least partially frozen, the operator make sure that the specimen is still flat; if not, he applies a firm pressure on the tissue to make it flat; after that, covering the part or all of the tissue margin with an initial volume of coating gel; using a mold for molding the part or all of the tissue margin covered by the initial volume of coating gel into the sample block having a predetermined configuration and a predetermined size; at least partially freezing the sample block while the sample block remains inserted in the mold; removing the sample block from the mold.

Typically, the part or all of the tissue margin has a substantially non-flat configuration, the method further comprising the step of substantially flattening the part of the tissue margin prior to covering the part or all of the tissue margin with an initial volume of coating gel.

Conveniently, flattening the part or all of the tissue margin includes making at least one substantially superficial incision in the shallow surface.

In accordance with the present invention, there is also provided a device for using part or all of the tissue margin of an excised tissue specimen and a coating gel to form a sample block sliceable into sample slices, the part or all of the tissue margin defining a peripheral section and a core section, the part or all of the tissue margin also defining a shallow surface and a substantially opposed deep surface, the device comprising: a piston component, the piston component including a tissue supporting surface, the tissue supporting surface defining a supporting surface peripheral edge; a sleeve component, the sleeve component defining a sleeve channel and a sleeve longitudinal axis; the sleeve component having a sleeve wall delimiting the sleeve channel, the sleeve wall defining a sleeve first end, a sleeve second end, a sleeve inner surface and a sleeve outer surface, the sleeve wall being configured and sized for substantially fittingly receiving the piston component and allowing reciprocating movement thereof along the sleeve longitudinal axis with the supporting surface peripheral edge in a substantially adjacent relationship relative to the sleeve inner surface; a molding plate, the molding plate including a molding surface; the molding plate being configured and sized so as to be positionnable in a plate molding configuration wherein the molding surface extends across the sleeve channel substantially adjacent the sleeve first end; whereby when the molding plate is in the plate molding configuration the molding surface, the supporting surface and the sleeve inner surface together encompass a molding volume for molding the sample block.

Typically, the molding plate defines an auxiliary surface positioned opposite the molding surface and a spacing surface extending between the molding and auxiliary surfaces, the molding plate being provided with a sealing ring extending substantially outwardly from the spacing surface.

Conveniently, the molding plate defines an auxiliary surface positioned opposite the molding surface, the molding plate being provided with a grasping rod extending substantially outwardly from the auxiliary surface for facilitating the manipulation of the molding plate.

Typically, the device further comprises an alignment means for aligning the molding surface in a substantially parallel relationship with the supporting surface.

Conveniently, the alignment means includes an abutment shoulder formed in the sleeve wall adjacent the sleeve first end, the abutment shoulder being configured, sized and positioned for abuttingly supporting the molding plate in the plate molding configuration.

Typically, the device further comprises a plate releasable locking means for releasably locking the molding plate in the plate molding configuration.

Conveniently, the plate releasable locking means includes a locking component, the locking component being configured and sized so as to be operationally positionable between the molding plate and the sleeve wall for maintaining the molding plate and the sleeve wall in a predetermined relationship relative to each other, the locking component being provided with a freezing aperture extending therethrough for allowing the flow of a freezing fluid through the freezing aperture towards the molding plate.

Typically, the plate releasable locking means includes a locking component, the locking component including a locking ring and a locking lip, the locking ring being configured and sized for operative engagement with the sleeve component, the locking lip being configured and sized for abutting against the auxiliary surface when the locking ring is operatively engaged with the sleeve component.

Conveniently, the locking ring is provided with an inner thread formed on an inner surface thereof and the sleeve component is provided with an outer thread formed on the sleeve outer surface for threadable engagement with the inner thread; the locking lip having a lip spacing segment extending substantially inwardly from the inner surface of the locking ring and a lip abutment segment extending substantially perpendicularly from the lip spacing segment for contacting the auxiliary surface.

Typically, the sleeve wall includes an abutment shoulder formed therein adjacent the sleeve first end, the abutment shoulder being configured, sized and positioned for abuttingly supporting the molding plate in the plate molding configuration; the sleeve wall also including a substantially axial sleeve flange extending from the abutment shoulder; the locking ring being provided with a ring spacing segment extending between the inner thread and the locking lip for accommodating the sleeve flange.

Conveniently, the device further comprises a piston positioning means for axially positioning the piston component at a predetermined axial position relative to the sleeve channel.

Typically, the piston positioning means allows the supporting surface to be moved between a piston molding position and a piston discharging position wherein the supporting surface is respectively positioned within the sleeve channel and axially outwardly relative to the piston channel; whereby the supporting surface allows the sample block to be molded when in the molding position and separated from the supporting surface when in the discharging position.

Conveniently, the piston positioning means includes a positioning rod extending from the piston component substantially opposite the supporting surface, the positioning rod being provided with effective length adjustment means for allowing adjustment of the effective length thereof used for adjusting the axial position of the piston component relative to the sleeve channel.

Typically, the effective length adjustment means includes a rod external thread formed on the positioning rod; a positioning flange extending inwardly from the sleeve inner surface adjacent the sleeve second end, the positioning flange being provided with a flange thread for threadably cooperating with the rod external thread in axially displacing the positioning rod relative to the sleeve component.

Conveniently, the device further comprises a base plate attached to the positioning rod opposite the piston component, the base plate being configured and sized for facilitating the manual rotation of the positioning rod.

Typically, the base plate is configured and sized so as to be usable as a device base positionable on a supporting surface for supporting the device in a substantially upright configuration.

In accordance with the present invention, there is further provided a device for transforming part or all of the tissue margin of an excised tissue specimen into a sample block sliceable into sample slices, the part or all of the tissue margin defining a peripheral section and a core section, the part or all of the tissue margin also defining a shallow surface and a substantially opposed deep surface, the device comprising: a tissue supporting component having a tissue supporting surface for supporting the part or all of the tissue margin, the tissue supporting surface defining a supporting surface peripheral edge; a molding structure for together with the tissue supporting surface providing a molding space of adjustable size, the molding structure including a peripheral molding wall extending substantially perpendicularly relative to the tissue supporting surface adjacent the supporting surface peripheral edge, the molding structure including a size adjustment means for allowing adjustment of the size of the peripheral molding wall; the molding structure also including an auxiliary molding wall extending in a substantially parallel and spaced relationship relative to the tissue supporting surface; a facilitating means for facilitating the freezing of the sample block.

Advantages of the present invention include that the proposed method and device allows an excised tissue sample to be properly flattened and remain integrally complete. The method and device allows the excised tissue sample to be initially manipulated by the surgeon with reduced needs of manipulation by technicians or other personnel leading to decreased risks of manipulation errors.

Also, the proposed method and device allows the first sections performed by the cryostat knife to include the entire formerly bowl-shaped surface. This, in turn, substantially decreases the time, cost and effort required for satisfactorily performing the Mohs surgical technique.

Furthermore, the proposed device is designed so as to be easily manufacturable using conventional forms of manufacturing so as to provide a device that will be economically feasible, long lasting and relatively trouble-free in operation.

### BRIEF DESCRIPTION OF THE DRAWNGS

An embodiment of the present invention will now be disclosed, by way of example, in reference to the following drawings in which:

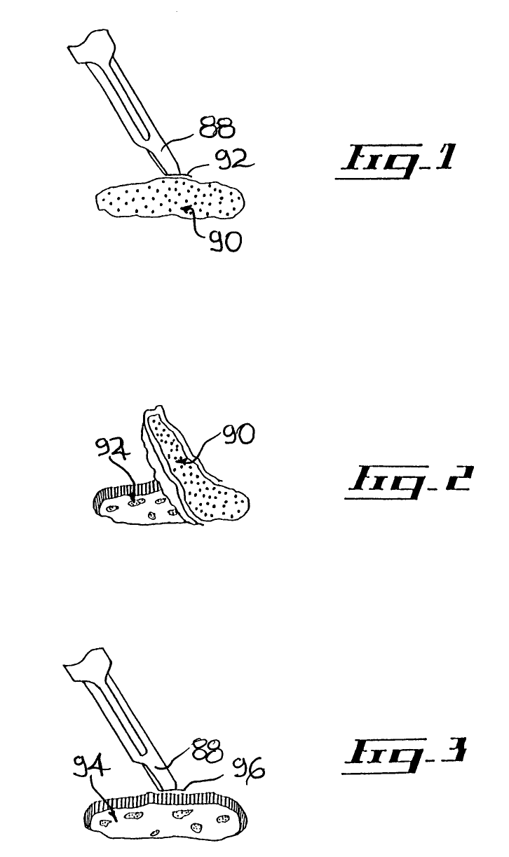

FIG. 1, in a perspective view with sections taken out, illustrates a scalpel blade being used for forming an incision around a tissue specimen containing the bulk of a cancerous mass;

FIG. 2, in a perspective view, illustrates the tissue specimen shown in FIG. 1 being excised from surrounding tissue;

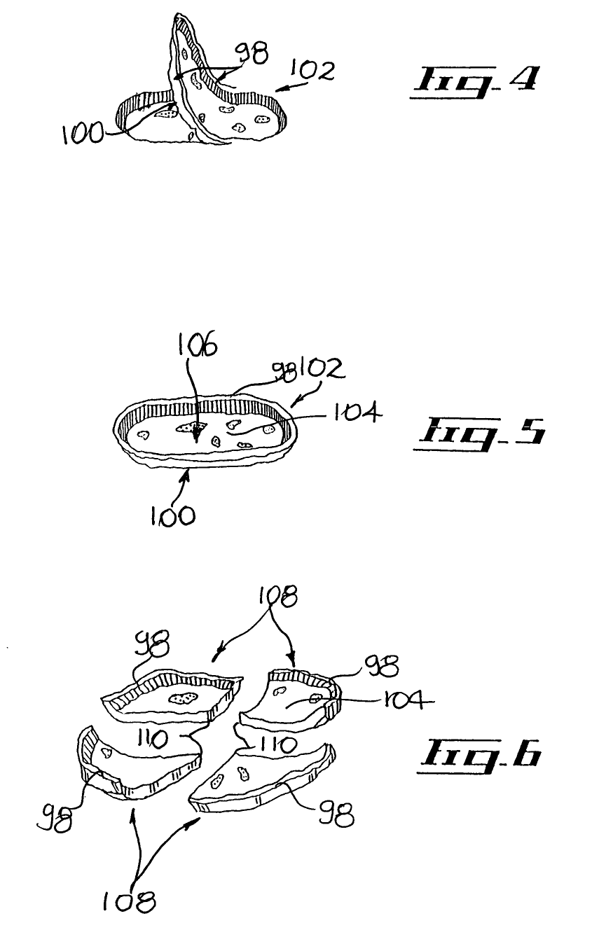

FIG. 3, in a partial perspective view with sections taken out, illustrates a scalpel blade being used for forming an incision around and underneath the wound shown in FIG. 2 created by excision of the tissue specimen containing the bulk of the cancerous mass;

FIG. 4, in a partial perspective view, illustrates the tissue margin of the excised tissue specimen being excised from around and underneath the wound bed;

FIG. 5, in a perspective view, illustrates an excised tissue margin;

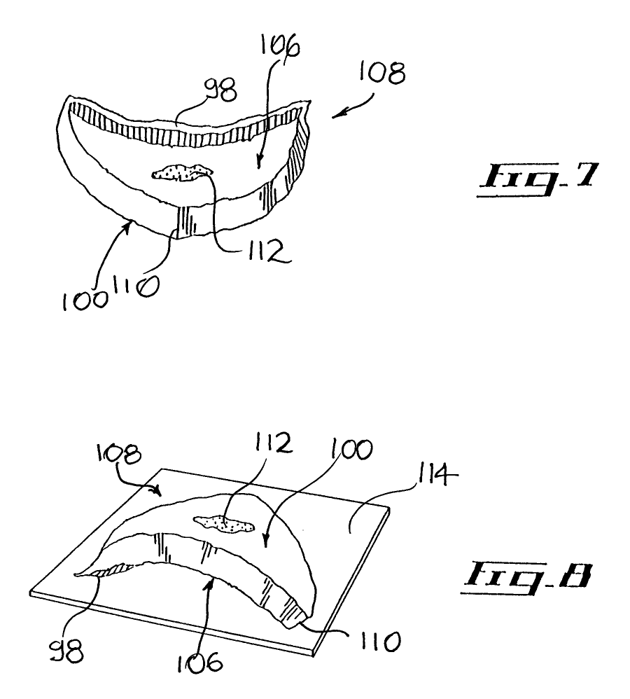

FIG. 6, in a perspective view, illustrates the excised tissue margin shown in FIG. 5 fragmented in four tissue margin fragments;

FIG. 7, in a perspective view, illustrates one of the tissue margin fragments shown in FIG. 6;

FIG. 8, in a perspective view, illustrates the tissue margin fragment shown in FIG. 7 mounted on a supporting surface in an inverted configuration wherein the deep surface thereof is positioned away from the supporting surface;

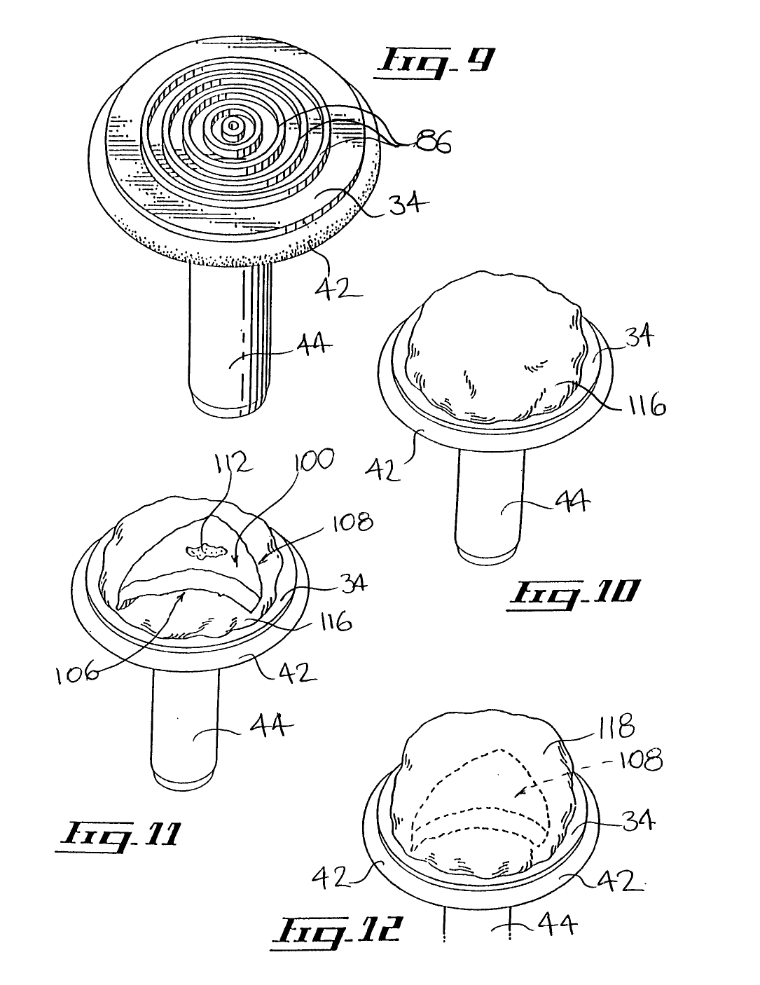

FIG. 9, illustrates a chuck conventionally used for tissue preparation for Mohs micrographic surgery;

FIG. 10, illustrates the conventional chuck shown in FIG. 9 having a layer of OCT compound resting thereon;

FIG. 11, in a perspective view, illustrates the conventional chuck in OCT compound shown in FIG. 10 having a tissue margin quadrant resting thereon in an inverted configuration wherein the deep surface of the tissue margin is positioned away from the chuck;

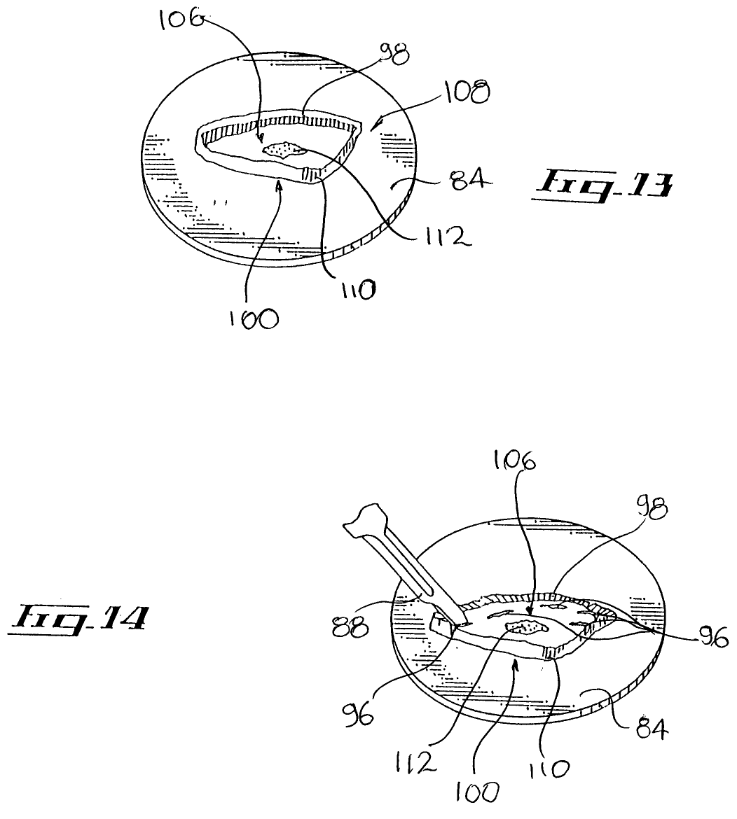

FIG. 12, in a partial perspective view, illustrates the chuck, OCT compound and tissue margin quadrant shown in FIG. 11 having a second layer of OCT compound positioned thereover;

FIG. 13, in a perspective view, illustrates a tissue margin quadrant resting on a supporting surface in a non-inverted configuration wherein the deep surface of the tissue margin rests on the supporting surface;

FIG. 14, in a partial perspective view with sections taken out, illustrates a scalpel blade being used for forming lacerations on the shallow surface of the tissue margin quadrant shown in FIG. 13;

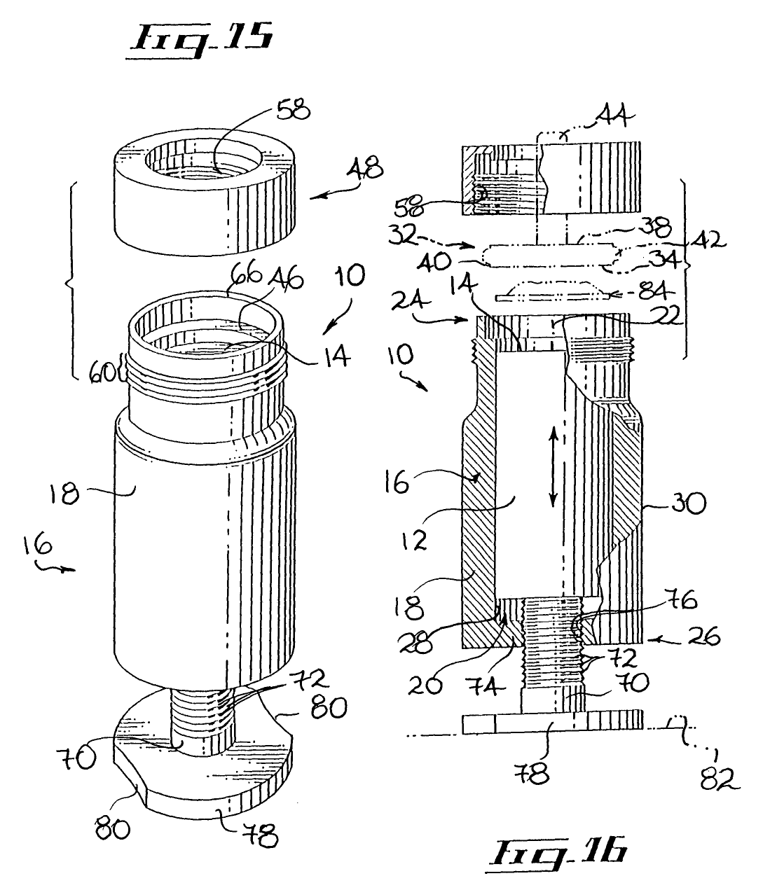

FIG. 15, illustrates a device for tissue preparation in accordance with an embodiment of the present invention;

FIG. 16, in a partial longitudinal cross-sectional view with sections taken out, illustrates some of the features of the device shown in FIG. 15;

FIG. 17, in a partial longitudinal cross-sectional view with sections taken out, illustrates an intermediate step of a tissue preparation method in accordance with an embodiment of the present invention being performed using a tissue preparation device also in accordance with an embodiment of the present invention;

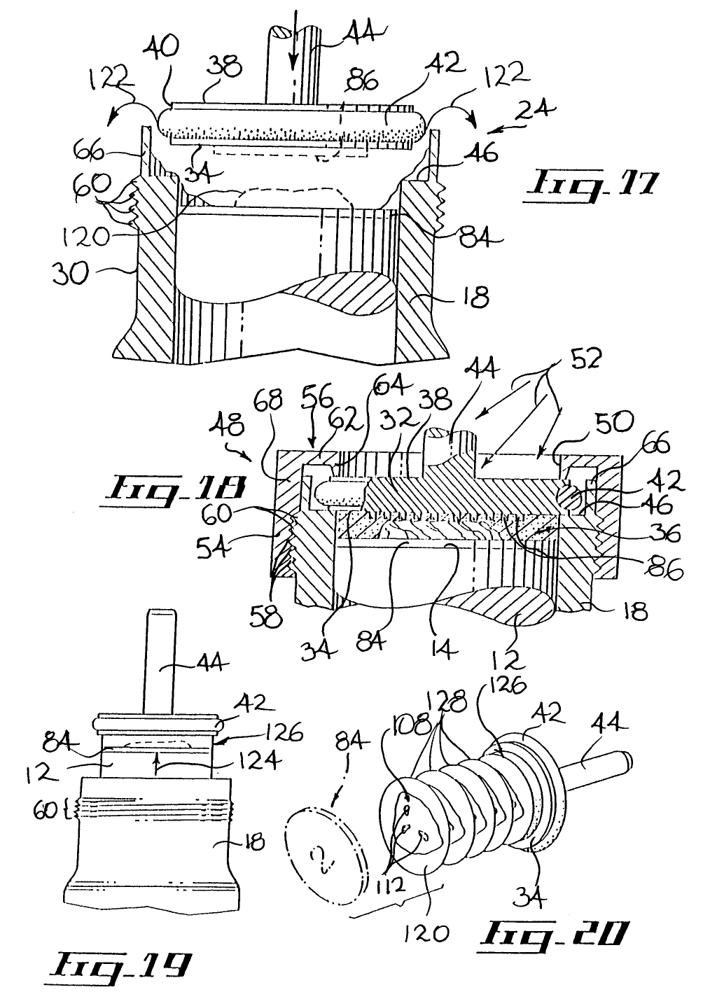

FIG. 18, in a partial longitudinal cross-sectional view with sections taken out, illustrates another step part of a tissue preparation method in accordance with an embodiment of the present invention being performed using the tissue preparation components shown in FIG. 17;

FIG. 19, in a partial elevational view with sections taken out illustrates a sample block formed using a method and device in accordance with the present invention about to be removed from the device;

FIG. 20, in a partial perspective view, illustrates a sample block formed using the method and device in accordance with the present invention being sliced into sample slices.

### DETAILED DESCRIPTION

Referring to FIGS. 15 and 16, there is shown a tissue preparation device in accordance with an embodiment of the present invention generally indicated by the reference numeral 10. The device 10 includes a piston component 12 defining a tissue supporting surface 14. The tissue supporting surface 14 typically has a substantially flat configuration and typically defines a supporting surface peripheral edge.

In the embodiment shown throughout the Figures, the piston component 12 has a substantially cylindrical configuration defining a generally disc-shaped tissue supporting surface 14 and a generally annular supporting surface peripheral edge. It should, however, be understood that the piston component 12 could have other configurations such as that of a rectangular or parallelepiped-shaped block without departing from the scope of the present invention.

The tissue preparation device 10 also includes a sleeve component 16. The sleeve component 16 has a sleeve wall 18 delimiting a sleeve channel 20. The sleeve wall 18 has a generally elongated configuration defining a sleeve longitudinal axis 22.

The sleeve wall 18 defines a sleeve first end 24, a sleeve second end 26, a sleeve inner surface 28 and a sleeve outer surface 30. The sleeve wall 18 is configured and sized for substantially fittingly receiving the piston component 12 and allowing reciprocating axial movement thereof along the sleeve longitudinal axis 22 with the supporting surface peripheral edge in a substantially adjacent relationship relative to the sleeve inner surface 28.

In situations such as shown throughout the figures wherein the piston component 12 has a substantially cylindrical configuration, the sleeve inner surface 28 has a corresponding substantially annular configuration. It should, however, be understood that in other embodiment wherein the piston component 12 has other transversal cross-sectional configurations, the configuration of the sleeve inner wall 28 is modified accordingly in order to allow the sleeve channel 26 to substantially fittingly receive the piston component 12.

The tissue preparation device 10 typically further includes a moulding plate 32 including a moulding surface 34. The moulding plate 32 is configured and sized so as to be positionable in a plate moulding configuration shown in FIG. 18 wherein the moulding surface 34 extends across the sleeve channel 20 substantially adjacent the sleeve first end 24. When the moulding plate 32 is in the plate moulding configuration, the moulding surface 34, the supporting surface 14 and the portion of the sleeve inner surface 28 extending therebetween together encompass a moulding volume 36 for moulding a sample block.

Typically, although by no means exclusively, the moulding plate 32 may be part of a conventional tissue preparation chuck. Typically, the moulding plate 32 defines an auxiliary surface 38 positioned opposite the moulding surface 34 and a spacing surface 40 extending between the moulding and auxiliary surfaces 34, 38. Also, typically, the moulding plate 32 is provided with a sealing ring 42 extending substantially outwardly from the spacing surface 40. Typically, although by no means exclusively, the sealing ring 42 is made out of a substantially resiliently deformable material such as an elastomeric resin.

Typically, the moulding plate 32 is provided with a grasping rod 44 extending substantially outwardly from the auxiliary surface 38 for facilitating the manipulation of the moulding plate 32.

The tissue preparation device 10 typically further includes an alignment means for aligning the moulding surface 34 in a substantially parallel relationship relative to the supporting surface 14. In the embodiment of the invention shown throughout the figures, the alignment means includes an abutment shoulder 46 formed in the sleeve wall 18 adjacent the sleeve first end 24. The abutment shoulder 46 is configured, sized and positioned for abuttingly supporting the moulding plate 32 in the plate moulding configuration such as shown in FIG. 18.

It should be understood that the tissue preparation device 10 could be provided without an alignment means or with other types of alignment means without departing from the scope of the present invention.

The tissue preparation device 10 typically further includes a plate releasable locking means for releasably locking the moulding plate 32 in the plate moulding configuration shown in FIG. 18. In the embodiment of the invention shown throughout the figures, the plate releasable locking means includes a locking component 48.

The locking component 48 is configured and sized so as to be operationally positionable between the moulding plate 32 and the sleeve wall 18 for maintaining the moulding plate 32 and the sleeve wall 18 in a predetermined relationship relative to each other. The locking component 48 is typically provided with a freezing aperture 50 extending therethrough for allowing the flow indicated by arrows 52 of a freezing fluid through the freezing aperture 50 towards the moulding plate 32. The freezing aperture 50 is hence adapted to act as a facilitating means for facilitating the freezing of the moulding plate 32 and, hence, of the sampling block formed by the tissue preparation device 10.

Typically, the locking component 48 includes a locking ring 54 and a locking lip 56. The locking ring 54 is configured and sized for operative engagement with the sleeve component 16. The locking lip 56 is configured and sized for abutting against the auxiliary surface 38 when the locking ring 54 is operatively engaged with the sleeve component 16.

Typically, the locking ring 54 is provided with an inner thread 58 formed on an inner surface thereof while the sleeve component 16 is provided with an outer thread 60 formed on the sleeve outer surface 30 for threadable engagement with the inner thread 58.

Typically, the locking lip 56 has a lip spacing segment 62 extending substantially inwardly from the inner surface of the locking ring 54 and a lip abutment segment 64 extending substantially perpendicularly from the lip spacing segment 62 for contacting the auxiliary surface 38.

Typically, the sleeve wall 18 further includes a substantially axial sleeve flange 66 extending from the abutment shoulder 46. Also, the locking ring 54 is typically provided with a corresponding ring spacing segment 68 extending between the inner thread 60 and the locking lip 56 for accommodating the sleeve flange 66.

The tissue preparation device 10 further includes a piston positioning means for axially positioning the piston component 12 at a predetermined axial position relative to the sleeve channel 20. The piston positioning means typically allows the supporting surface 14 to be moved between a piston moulding position shown in FIGS. 16 through 18 and a piston discharging position shown in FIG. 19. In the piston moulding position, the supporting surface 14 is positioned within the sleeve channel 20 while in the piston discharging position, the supporting surface 14 is positioned axially outwardly relative to the piston channel 20.

In the embodiment of the invention shown throughout the figures, the piston positioning means includes a positioning rod 70 extending from the piston component 12 substantially opposite the supporting surface 14. The positioning rod 70 is provided with an effective length adjustment means for allowing adjustment of the effective length thereof used for adjusting the axial position of the piston component 12 relative to the sleeve channel 20.

In the embodiment of the invention shown throughout the Figures, the effective length adjustment means includes a rod external thread 72 formed on the outer surface of the positioning rod 70. The effective length adjustment means also includes a positioning flange 74 extending circumferentially inwardly from the sleeve inner surface 28 adjacent the sleeve second end 26. The positioning flange 74 is provided with a flange thread 76 for threadably cooperating with the rod external thread 72 in axially displacing the positioning rod 70 relative to the sleeve component 16.

The tissue preparation device is typically further provided with a base plate 78 attached to the positioning rod 70 opposite the piston component 12. The base plate 78 is configured and sized for facilitating the manual rotation of the positioning rod 70. For example, the base plate 78 may be provided with finger-receiving recesses 80 formed about its peripheral edge for receiving the pulp of opposite grasping fingers.

The base plate 78 is preferably configured and sized so as to be also useable as a device base positionable on a supporting surface 82 for supporting the device 10 in a substantially upright configuration such as shown in FIG. 15.

Optionally, the tissue preparation device 10 is still further provided with a supporting plate 84 positionable in abutting engagement with the supporting surface 14. The supporting plate is typically made out of a suitable material such as stainless steel or glass and coated with a coating layer of suitable polymeric resin. Also, optionally, the plate moulding surface 34 is provided with friction enhancing means for enhancing the friction coefficient thereof. The friction enhancing means may take any suitable form such as concentric annular protrusions 86 protruding substantially outwardly therefrom.

The present invention also relates to a method for using part of the tissue margin or an excised tissue specimen and a coating gel to form a sample block sliceable into sample slices. The method in accordance with the present invention hence provides steps for obtaining tissue specimens for Mohs micrographic surgery.

FIGS. 1 through 6 illustrate various steps and by-products of such steps common to both prior art methods and the method in accordance with the present invention. Typically, the bulk of a cancerous mass 90 is initially removed by curettage. FIG. 1 illustrates a conventional scalpel blade 88 forming an incision 92 around the bulk of the cancerous mass 90 so as to allow excision of the latter.

FIG. 2 illustrates the bulk of cancerous mass 90 hereinafter referred to as the excised tissue specimen being lifted away from adjacent tissue. The removal of the excised tissue specimen creates a generally concave wound bed 94. FIG. 3 illustrates the scalpel blade 88 being used for forming an incision 96 peripherally adjacent the wound bed 94 for creating a layer or margin of tissue encompassing the entire wound bed 94.

The incision 96 is typically created around and underneath the wound bed 94 so as to create a gradual transition between lateral or peripheral margin sections 98 and deep margin sections or surface 100. Typically, although by no means exclusively, the scalpel blade 88 is angled between 30 and 45 degrees relative to the surface of the tissue surrounding the wound bed 94.

FIG. 4 illustrates the tissue margin 102 encompassing the entire wound bed 94 being lifted away from surrounding tissue. FIG. 5 illustrates the typically generally concave or bowl-shaped configuration of the tissue margin 102 defining a raised peripheral or epithelial section 98 and a central or core section 104. The tissue margin 102 also defines an upper or shallow surface 106 positioned substantially opposite the lower or deep surface 100.

FIG. 6 illustrates, the typically bowl- or concave-shaped tissue margin 102 having been fragmented in fragments, part or quadrants 108. Each part or quadrant 108 typically has a substantially “pie slice” configuration defining a corresponding quadrant apex 110. The parts or quadrants are typically marked with tissue dyes or other means for later identification. Typically, the quadrants are dyed from the epithelial border 98 (to the apex 110.

FIG. 7 illustrates a quadrant or part 108 of the tissue margin 102 having been isolated from the other parts 108. The part 108 is shown containing a cancerous island 112. FIG. 8 illustrates the quadrant 108 mounted on a supporting surface 114. The quadrant 108 is shown in a substantially convex inverted configuration wherein the shallow surface 106 is positioned adjacent the supporting surface 114 and the deep surface 100 is positioned opposite the supporting surface 114.

FIG. 9, in a perspective view, illustrates a chuck or supporting component used in both prior art methods and the method in accordance with the present invention. FIGS. 10 through 12 illustrate various steps part of a prior art method of tissue preparation.

As shown in FIG. 10, the prior art method initially involves coating the moulding surface 34 of a conventional supporting component or chuck with a suitable first layer 116 of coating gel. The conventional coating gel typically used is a so-called OCT gel. The OCT fluid is a clear, tissue mounting fluid such as the fluid sold under the brand name “Tissue Tek II OCT compound” by Miles Laboratories Inc.

As shown in FIG. 11, a quadrant 108 is then typically positioned on the first layer 116 of coating gel in a generally convex and inverted configuration with the deep surface 100 thereof positioned away from the moulding surface 34. Optionally, the exposed deep surface 100 has lacerations formed therein to facilitate flattening of the quadrant 108.

As shown in FIG. 12, the quadrant 108 is then covered with a second layer 118 of OCT gel. Liquid nitrogen or other suitable freezing means are then used to freeze the quadrant 108.

FIGS. 13, 14 and 17 through 20 illustrate some of the steps of a method in accordance with an embodiment of the invention. FIG. 13 illustrates a quadrant 108 mounted on a supporting plate 84. The quadrant 108 is mounted so as to be in a substantially convex configuration with the deep surface 100 thereof in abutting contact with the supporting plate 84.

FIG. 14 illustrates the quadrant 108 positioned on the supporting plate 84 and having flattening incisions 96 made on the exposed shallow surface 106 leaving the deeper surface 100 substantially unaltered.

Optionally, the device 10 is previously cooled to temperatures in the range of −24 to −26 degrees Celsius to reduce the temperature gradient to which the quadrant 108 will be subjected during subsequent freezing thereof. As illustrated in FIG. 17, the supporting plate with the quadrant 108 resting thereon is then abuttingly rested on the tissue supporting surface 14. A covering layer 120 of OCT gel is then applied over the quadrant 108. The moulding surface 34 of the chuck is then used for compressing the covering layer of OCT gel. As illustrated schematically by arrows 122 excess gel compressed by the molding surface 34 is allowed to escape laterally between the sealing ring 42 and the sleeve flange 66.

As illustrated in FIG. 18, the chuck is lowered until the peripheral edge of the molding surface 34 abuttingly contacts the abutment shoulder hence preventing the quadrant from being crushed.

The tissue supporting surface 14 or the supporting plate 84 resting thereon, the molding surface 34 and the portion of sleeve inner surface 28 extending therebetwen hence together form a mold for molding part of the tissue margin 102 covered by the volume or covering layer 120 of coating gel into a sample block having a predetermined configuration and a predetermined size corresponding to that of the molding volume 36.

As shown in FIG. 18, the locking component 48 may be optionally used for releasably locking the molding surface in place. The freezing aperture 50 allows a spray 52 of suitable freezing fluid to be directed towards the sample block for freezing the latter. Typically, the freezing step lasts for approximately 20 to 30 seconds.

Once the freezing step is completed, the locking component 48 is removed and rotation of the base plate 78 biases the molded sample block 126 outwardly as indicated by arrow 124 in FIG. 19.

As illustrated in FIG. 20, the supporting plate 84 is then separated from the molded sample block 126. A conventional cryostat knife may then be used for slicing the molded sample block 126 transversally into suitable sample slices 128 typically having a thickness in the range of 5 microns.

Although throughout the Figures the sample block 126 is shown as having a substantially cylindrical configuration with a substantially disc-shaped cross-section, it should be understood that the proposed method and device 10 could be used for producing sample blocks having other configurations without departing from the scope of the present invention. For example, for relatively soft tissues such as liver tissues, a substantially cubic sample block could be formed allowing any combinations of its six faces to be sliced for providing additional information on the nature of the frozen tissue.

The embodiments of the invention in which an exclusive privilege or property is claimed are defined as follows:

1. A method for using a tissue margin of an excised tissue specimen and a coating gel to form a sample block sliceable into sample slices, said tissue margin defining a peripheral section and a core section, said tissue margin also defining a shallow surface and a substantially opposed deep surface, said method comprising the steps of:
positioning said tissue margin on a substantially flat tissue supporting surface with said deep surface positioned adjacent or against said tissue supporting surface;
covering said tissue margin with an initial volume of coating gel;
using a mold for molding said tissue margin covered by said initial volume of coating gel into said sample block having a predetermined configuration and a predetermined size;
at least partially freezing said sample block while said sample block remains inserted in said mold;
removing said sample block from said mold.

2. A method as recited in claim 1 wherein said tissue margin has a substantially non-flat configuration, said method further comprising the step of substantially flattening said tissue margin prior to covering said tissue margin with an initial volume of coating gel.

3. A method as recited in claim 2 wherein flattening said tissue margin includes making at least one substantially superficial incision in said shallow surface.

4. A device for using tissue margin of an excised tissue specimen and a coating gel to form a sample block sliceable into sample slices, said tissue margin defining a peripheral section and a core section, said tissue margin also defining a shallow surface and a substantially opposed deep surface, said device comprising:
a piston component, said piston component including a tissue supporting surface, said tissue supporting surface defining a supporting surface peripheral edge;
a sleeve component, said sleeve component defining a sleeve channel and a sleeve longitudinal axis; said sleeve component having a sleeve wall delimiting said sleeve channel, said sleeve wall defining a sleeve first end, a sleeve second end, a sleeve inner surface and a sleeve outer surface, said sleeve wall being configured and sized for substantially fittingly receiving said piston component and allowing reciprocating movement thereof along said sleeve longitudinal axis with said supporting surface peripheral edge in a substantially adjacent relationship relative to said sleeve inner surface;
a molding plate, said molding plate including a molding surface; said molding plate being configured and sized so as to be positionnable in a plate molding configuration wherein said molding surface extends across said sleeve channel substantially adjacent said sleeve first end;
whereby when said molding plate is in said plate molding configuration said molding surface, said supporting surface and said sleeve inner surface together encompass a molding volume for molding said sample block.

5. A device as recited in claim 4 wherein said molding plate defines an auxiliary surface positioned opposite said molding surface and a spacing surface extending between said molding and auxiliary surfaces, said molding plate being provided with a sealing ring extending substantially outwardly from said spacing surface.

6. A device as recited in claim 4 wherein said molding plate defines an auxiliary surface positioned opposite said molding surface, said molding plate being provided with a grasping rod extending substantially outwardly from said auxiliary surface for facilitating the manipulation of said molding plate.

7. A device as recited in claim 4 further comprising alignment means for aligning said molding surface in a substantially parallel relationship with said supporting surface.

8. A device as recited in claim 7 wherein said alignment means includes an abutment shoulder formed in said sleeve wall adjacent said sleeve first end, said abutment shoulder being configured, sized and positioned for abuttingly supporting said molding plate in said plate molding configuration.

9. A device as recited in claim 4 further comprising a plate releasable locking means for releasably locking said molding plate in said plate molding configuration.

10. A device as recited in claim 9 wherein said plate releasable locking means includes a locking component, said locking component being configured and sized so as to be operationally positionable between said molding plate and said sleeve wall for maintaining said molding plate and said sleeve wall in a predetermined relationship relative to each other, said locking component being provided with a freezing aperture extending therethrough for allowing the flow of a freezing fluid through said freezing aperture towards said molding plate.

11. A device as recited in claim 9 wherein said plate releasable locking means includes a locking component, said locking component including a locking ring and a locking lip, said locking ring being configured and sized for operative engagement with said sleeve component, said locking lip being configured and sized for abutting against said auxiliary surface when said locking ring is operatively engaged with said sleeve component.

12. A device as recited in claim 11 wherein said locking ring is provided with an inner thread formed on an inner surface thereof and said sleeve component is provided with an outer thread formed on said sleeve outer surface for threadable engagement with said inner thread; said locking lip having a lip spacing segment extending substantially inwardly from the inner surface of said locking ring and a lip abutment segment extending substantially perpendicularly from said lip spacing segment for contacting said auxiliary surface.

13. A device as recited in claim 12 wherein said sleeve wall includes an abutment shoulder formed therein adjacent said sleeve first end, said abutment shoulder being configured, sized and positioned for abuttingly supporting said molding plate in said plate molding configuration; said sleeve wall also including a substantially axial sleeve flange extending from said abutment shoulder; said locking ring being provided with a ring spacing segment extending between said inner thread and said locking lip for accommodating said sleeve flange.

14. A device as recited in claim 4 further comprising a piston positioning means for axially positioning said piston component at a predetermined axial position relative to said sleeve channel.

15. A device as recited in claim 14 wherein said piston positioning means allows said supporting surface to be moved between a piston molding position and a piston discharging position wherein said supporting surface is respectively positioned within said sleeve channel and axially outwardly relative to said piston channel; whereby said supporting surface allows said sample block to be molded when in said molding position and separated from said supporting surface when in said discharging position.

16. A device as recited in claim 14 wherein said piston positioning means includes a positioning rod extending from said piston component substantially opposite said supporting surface, said positioning rod being provided with effective length adjustment means for allowing adjustment of the effective length thereof used for adjusting the axial position of said piston component relative to said sleeve channel.

17. A device as recited in claim 16 wherein said effective length adjustment means includes
a rod external thread formed on said positioning rod;
a positioning flange extending inwardly from said sleeve inner surface adjacent said sleeve second end, said positioning flange being provided with a flange thread for threadably cooperating with said rod external thread in axially displacing said positioning rod relative to said sleeve component.

18. A device as recited in claim 17 further comprising a base plate attached to said positioning rod opposite said piston component, said base plate being configured and sized for facilitating the manual rotation of said positioning rod.

19. A device as recited in claim 18 wherein said base plate is configured and sized so as to be usable as a device base positionable on a supporting surface for supporting said device in a substantially upright configuration.

20. A device for transforming a tissue margin of an excised tissue specimen into a sample block sliceable into sample slices, said tissue margin defining a peripheral section and a core section, said tissue margin also defining a shallow surface and a substantially opposed deep surface, said device comprising:
a tissue supporting component having a tissue supporting surface for supporting said tissue margin, said tissue supporting surface defining a supporting surface peripheral edge;
a molding structure for together with said tissue supporting surface providing a molding space of adjustable size, said molding structure including a peripheral molding wall extending substantially perpendicularly relative to said tissue supporting surface adjacent said supporting surface peripheral edge, said molding structure including a size adjustment means for allowing adjustment of the size of said peripheral molding wall; said molding structure also including an auxiliary molding wall extending in a substantially parallel and spaced relationship relative to said tissue supporting surface;
a facilitating means for facilitating the freezing of said sample block.
